(19) United States
(12) Patent Application Publication
(10) Pub. No.: US 2009/0312068 A1
(43) Pub. Date: Dec. 17, 2009

(54) SYSTEM AND METHOD FOR SETTING AND SELECTING A COMMUNICATION MODE OF A COMMUNICATION DEVICE

(75) Inventor: CHIEN-CHIH KUO, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/337,638

(22) Filed: Dec. 18, 2008

(30) Foreign Application Priority Data
Jun. 17, 2008 (CN) 200810302166.3

(51) Int. Cl. H04M 1/00

(52) U.S. Cl. 455/569.1

(57) ABSTRACT

A method and system for selecting a communication mode of a communication device include setting a plurality of communication modes of the communication device and setting division standards of the plurality of communication modes. The system and method further determines a peripheral status and a placement status of the communication device when the communication device receives a signal to establish a communication connection, and selects a communication mode for during the communication connection.

### BACKGROUND

1. Field of the Invention

Embodiments of the present disclosure relate to managing communication devices, and more particularly to a system and method for selecting a communication mode of a communication device.

2. Description of Related Art

Making phone calls is a basic functionality of mobile phones. Generally, mobile phones provide one or more communication modes for answering incoming calls from others or making phone calls with others. However, switching between the communication modes during the phone calls is not easy to implement.

What is needed, therefore, is an improved system and method for selecting a communication mode of a communication device to overcome the above-stated problems.

### BRIEF DESCRIPTION OF THE DRAWINGS

FIG. 1 is a block diagram of one embodiment of a system for setting and selecting a communication mode of a first communication device.

FIG. 2 is a block diagram of one embodiment of the first communication device.

FIG. 3A and FIG. 3B are flowcharts of one embodiment of a method for setting and selecting a communication mode of a first communication device.

### DETAILED DESCRIPTION OF CERTAIN INVENTIVE EMBODIMENTS

All of the processes described below may be embodied in, and fully automated via, software code modules executed by one or more general purpose computers or processors. The code modules may be stored in any type of computer-readable medium or other storage device. Some or all of the methods may alternatively be embodied in specialized computer hardware or communication apparatus.

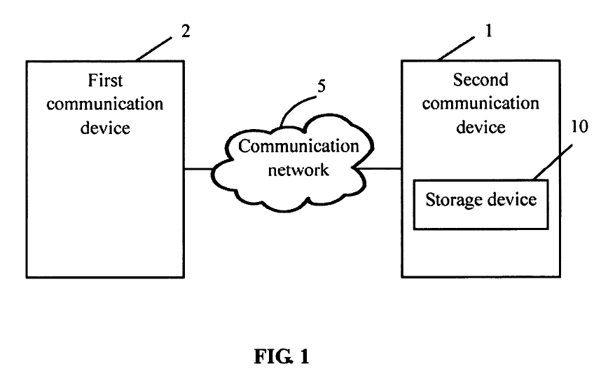

FIG. 1 is a block diagram of one embodiment of a system for setting and selecting a communication mode of a first communication device 2 (hereinafter referred to as “the selecting system”). Depending on the embodiment of the present disclosure, the selecting system may include the first communication device 2 and a second communication device 1. The first communication device 2 may communicate with the second communication device 1 through a communication network 5. Depending on the embodiment, the communication network 5 may be the Global System for Mobile communication (GSM) network, the General Packet Radio Service (GPRS) network, or the Internet, for example.

The selecting system is used for setting a plurality of communication modes in the first communication device for answering incoming calls from the second communication device 1 or making phone calls to the second communication device 1, and switching between the communication modes according to changed conditions.

The second communication device 1 includes a storage device 10 and is used for storing various data, such as an operating system, applications, and various data related thereof. Depending on the embodiment, the first communication device 2 and the second communication device 1 may be mobile phones, personal digital assistants, or computing devices.

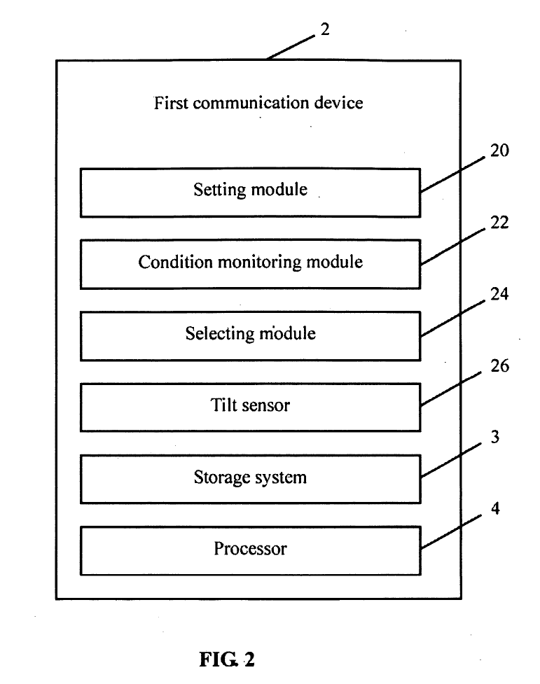

FIG. 2 is a block diagram of one embodiment of the first communication device 2. In one embodiment, the first communication device 2 may include a setting module 20, a condition monitoring module 22, a selecting module 24, and a tilt sensor 26. The first communication device 2 may further include a storage system 3 and at least one processor 4. The modules 20, 22, 24 and the tilt sensor 26 may be used to perform one or more operations for the first communication device 2.

Additionally, the first communication device 2 may include one or more specialized or general purpose processors, such as the processor 4 for executing the modules 20, 22, 24 and the tilt sensor 26. The storage system 3 is for storing various kinds of data, such as the data set by the selecting system, communication records, short messages, etc. Depending on the embodiment, the storage system 3 may be a memory of the first communication device 2 or an external storing card, such as a memory stick, a subscriber identity module (SIM) card, or some combination thereof, but the disclosure is not limited thereto.

The setting module 20 is configured for setting a plurality of communication modes of the first communication device 2, and setting division standards of the plurality of communication modes according to a peripheral status and a placement status of the first communication device 2. A greater explanation of the setting division standards is described below.

In one embodiment of the present disclosure, the plurality of communication modes may include, but are not limited to, a headset mode, a hands-free mode, and a hand-held mode of the first communication device 2. The headset mode facilitates communication, such as a phone call, using a headset connected to the first communication device 2. The hands-free mode facilitates the communication using a microphone/loudspeaker of the first communication device 2. The hand-held mode facilitates the communication using a handset of the first communication device 2. The plurality of communication modes may be selected for answering an incoming call or making a phone call.

In one embodiment of the present disclosure, the division standards may include, but are not limited to, the peripheral status and the placement status of the first communication device 2. The peripheral status of the first communication device 2 may be a headset connected state or a headset disconnected state. The placement status of the first communication device 2 may a horizontal state or a non-horizontal state of a placement of the first communication device 2. The horizontal state is determined by determining if the first communication device 2 is laid/placed horizontally on an object, such as a desk, a bed, etc. The communication modes and the division standards may be modified according to actual requirements.

The peripheral status and the placement status of the first communication device 2 may be changed during the communication, and then the communication modes may be switched accordingly.

The condition monitoring module 20 is configured for confirming a peripheral status and a placement status of the first communication device 2 when the first communication device 2 receives a call signal to establish a communication connection with the second communication device 1. Depending on the embodiment, the call signal may be indicative of an incoming call signal or indicative of a signal to make a call.

The selecting module 24 is configured for selecting a communication mode according to the peripheral status and the placement status of the first communication device 2 and the division standards.

The tilt sensor 26 is used for detecting a gradient value of the first communication device 2. The condition monitoring module 22 determines that the first communication device 2 is placed horizontally if the gradient value is equal to about zero, and determines that the first communication device 2 is not placed horizontally if the gradient value is not equal to about zero. Depending on the embodiment of the present disclosure, the gradient value is an angle between the first communication device 2 and a plane of the object (e.g. a desk).

In one embodiment, when the first communication device 2 receives an incoming call from the second communication device 1, the selecting module 24 selects the headset mode of a headset connected to the first communication device 2 if the condition monitoring module 22 determines that the first communication device 2 is connected with any headset. The headset may be a Bluetooth (BT) headset or any other kind of headset.

In another embodiment, when the first communication device 2 receives the incoming call and the first communication device 2 is not connected to any headset, the selecting module 24 selects the hands-free mode with the microphone of the first communication device 2 if the condition monitoring module 22 determines that the first communication device 2 is placed horizontally. Additionally, the selecting module 24 selects the hand-held mode with the handset of the first communication device 2 if the condition monitoring module 22 determines that the first communication device 2 is not placed horizontally. For example, if the user of the first communication device 2 drives a car when the incoming call is received, the user may place the first communication device 2 horizontally so as to answer the incoming call under the hands-free mode.

The condition monitoring module 22 and the selecting module 24 are further configured for determining if the peripheral status and/or the placement status of the first communication device 2 has been changed, and switching to a corresponding communication mode accordingly.

In one embodiment, if the user removes the headset from the first communication device 2 and places the first communication device 2 horizontally, the condition monitoring module 22 determines that the first communication device 2 is not connected with any headset and determines that the first communication device 2 is placed horizontally through the tilt sensor 26, and the selecting module 24 accordingly switches a current headset mode to the hands-free mode.

In another embodiment, if the user removes the headset from the first communication device 2 and holds the first communication device 2 by hands, the condition monitoring module 22 determines that the first communication device 2 is not connected with any headset and determines that the first communication device 2 is not placed horizontally through the tilt sensor 26, then the selecting module 24 switches the currently headset mode to the hand-held mode.

In another embodiment, if the user connects the headset with the first communication device 2 that is placed horizontally, the condition monitoring module 22 determines that the first communication device 2 is connected with the headset, then the selecting module 24 switches a currently hand-held mode to the headset mode.

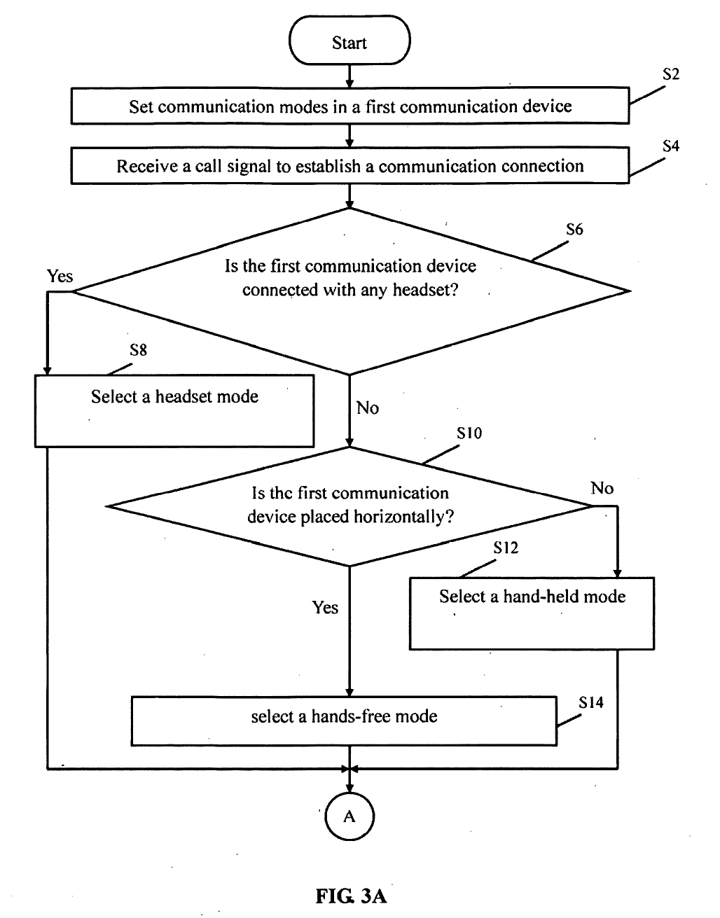

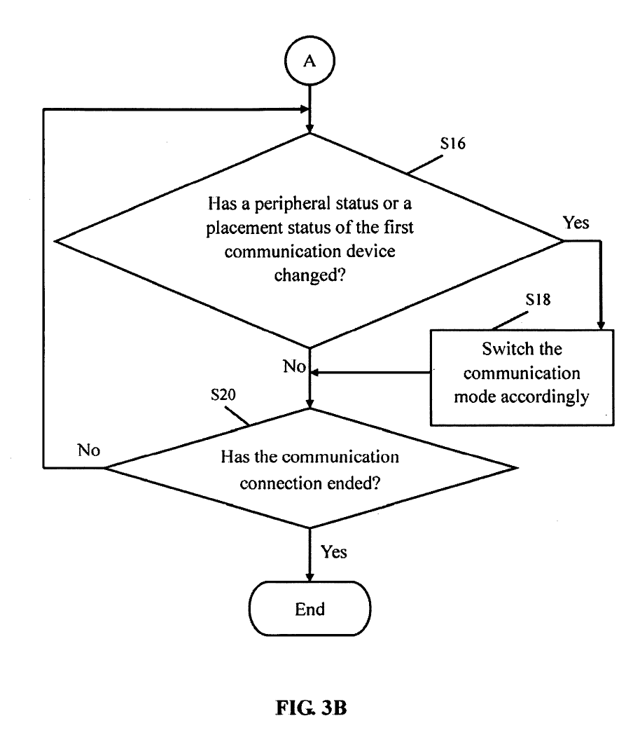

FIG. 3A and FIG. 3B are flowcharts of one embodiment of a method for setting and selecting a communication mode of a first communication device. Depending on the embodiment, additional blocks may be added, others removed, and the ordering of the blocks may be changed.

In block S2, the setting module 20 sets a plurality of communication modes in the first communication device 2, and sets division standards of the plurality of communication modes according to a peripheral status and a placement status of the first communication device 2.

In block S4, the first communication device 2 receives a call signal to establish a communication connection with the second communication device 1. Depending on the embodiment, the call signal may be indicative of an incoming call signal or indicative of a signal to make a call.

In block S6, the condition monitoring module 22 detects the peripheral status of the first communication device 2 by determining if the first communication device 2 is connected with any headset. If the first communication device 2 is connected with a headset, the peripheral status of the first communication device 2 is determined to be the headset connected state. Accordingly, in block S8, the selecting module 24 selects the headset mode to answer an incoming call or to make a call, and then the procedure goes to block S16 directly.

If the first communication device 2 is not connected with any headset, the peripheral status of the first communication device 2 is determined to be the headset disconnected state. Accordingly, in block S10, the condition monitoring module 22 detects the placement status of the first communication device 2 by determining if the first communication device 2 is placed horizontally.

The placement status of the first communication device 2 is determined by detecting a gradient value of the first communication device 2 through the tilt sensor 26. If the gradient value is equal to about zero, the condition monitoring module 22 determines that the first communication device 2 is placed horizontally and the placement status is determined to be the horizontal state; otherwise, if the gradient value is not equal to about zero, the condition monitoring module 22 determines that the first communication device 2 is not placed horizontally and the placement status is determined to be the non-horizontal state. It may be understood that the condition monitoring module 22 may determine that the first communication device 2 is horizontal if the tilt sensor determines that the gradient value is less than a predetermined angle, such as five degrees, for example.

If the placement status is determined to be the horizontal state, in block S12, the selecting module 24 selects the hand-held mode to answer an incoming call or make a call with the handset of the first communication device 2, and then the procedure goes to block S16 directly.

If the placement status is determined to be the non-horizontal state, in block S14, the selecting module 24 selects the hand-free mode to answer an incoming call or make a call with the microphone of the first communication device 2.

In block S16, the condition monitoring module 22 detects if the peripheral status or the placement status of the first communication device 2 has been changed during the communication connection. If the peripheral status or the placement status of the first communication device 2 has been changed during the communication connection, in block S18, the selecting module 24 switches to a corresponding communication mode accordingly.

If the peripheral status and the placement status of the communication device has not been changed during the communication connection, in block S20, the condition monitoring module 22 determines if the communication connection has ended. If the communication has ended, the procedure ends; otherwise, if the communication has not ended, the procedure returns to block S16.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A computing system for setting and selecting a communication mode of a communication device, the system comprising:
a setting module configured for setting a plurality of communication modes of the communication device, and setting division standards of the plurality of communication modes according to a peripheral status and a placement status of the communication device;
a condition monitoring module configured for confirming a peripheral status and a placement status of the communication device;
a selecting module configured for selecting a communication mode according to the peripheral status, the placement status of the communication device, and the division standards;
the condition monitoring module further configured for determining if the peripheral status or the placement status of the communication device has been changed;
the selecting module further configured for switching the communication mode accordingly if the peripheral status or the placement status of the communication device has been changed; and
at least one processor that executes the setting module, the condition monitoring module, and the selecting module.

2. The system according to claim 1, wherein the peripheral status of the communication device comprises a headset connected state and a headset disconnected state of a headset being correspondingly connected or disconnected to the communication device, and wherein the placement status of the communication device comprises a horizontal state and a non-horizontal state of a placement of the communication device.

3. The system according to claim 1, wherein the plurality of communication modes comprise:
a headset mode that facilitates communication of the communication device using a headset connected to the communication device;
a hands-free mode that facilitates the communication using a microphone of the communication device; and
a hand-held mode that facilitates the communication using a handset of the communication device.

4. The system according to claim 3, wherein the condition monitoring module determines the peripheral status of the communication by determining if the communication device is connected with a headset.

5. The system according to claim 4, wherein the selecting module selects the headset mode if the communication device is connected with the headset.

6. The system according to claim 4, further comprising a tilt sensor for detecting a gradient value of the communication device.

7. The system according to claim 6, wherein the condition monitoring module is further configured for determining that the communication device is placed horizontally if the gradient value is equal to about zero, and determining that the communication device is not placed horizontally if the gradient value is not equal to about zero.

8. The system according to claim 7, wherein the selecting module selects the hands-free mode if the communication device is placed horizontally, or selects the hand-held mode if the communication device is not placed horizontally.

9. A computer-implemented method for setting and selecting a communication mode of a first communication device, the method comprising:
setting a plurality of communication modes of the first communication device, and setting division standards of the plurality of communication modes according to a peripheral status and a placement status of the first communication device;
receiving a call signal to establish a communication connection with a second communication device;
confirming a peripheral status and a placement status of the first communication device, and selecting a communication mode according to the peripheral status, the placement status of the first communication device, and the division standards;
determining if the peripheral status or the placement status of the first communication device has been changed during the communication connection; and
switching the communication mode accordingly if the peripheral status or the placement status of the first communication device has been changed during the communication connection.

10. The method according to claim 9, wherein the plurality of communication modes comprise:
a headset mode that facilitates communication of the first communication device using a headset connected to the communication device;
a hands-free mode that facilitates the communication using a microphone of the first communication device; and
a hand-held mode that facilitates the communication using a handset of the first communication device.

11. The method according to claim 10, wherein the step of confirming a peripheral status and a placement status of the first communication device, and selecting a communication mode according to the peripheral status, the placement status of the first communication device, and the division standards comprises:
determining if the first communication device is connected with a headset; and
selecting the headset mode if the first communication device is connected with the headset.

12. The method according to claim 10, wherein the step of confirming a peripheral status and a placement status of the first communication device, and selecting a communication mode according to the peripheral status, the placement status of the first communication device, and the division standards further comprises:
detecting a gradient value of the first communication device if the first communication device is not connected with any headset; and
determining that the first communication device is placed horizontally if the gradient value is equal to about zero, and selecting the hands-free mode; or
determining that the first communication device is not placed horizontally if the gradient value is not equal to about zero, and selecting the hand-held mode.

13. A computer-readable medium having stored thereon instructions that, when executed by a processor of a first communication device, causing the processor to perform a method for setting and selecting a communication mode of the first communication device, the method comprising:
setting a plurality of communication modes of the first communication device, and setting division standards of the plurality of communication modes according to a peripheral status and a placement status of the first communication device;
receiving a call signal to establish a communication connection with a second communication device;
confirming a peripheral status and a placement status of the first communication device, and selecting a communication mode according to the peripheral status, the placement status of the first communication device, and the division standards;
determining if the peripheral status or the placement status of the first communication device has been changed during the communication connection; and
switching the communication mode accordingly if the peripheral status or the placement status of the first communication device has been changed during the communication connection.

14. The medium according to claim 13, wherein the plurality of communication modes comprise:
a headset mode that facilitates communication of the first communication device using a headset connected to the communication device;
a hands-free mode that facilitates the communication using a microphone of the first communication device; and
a hand-held mode that facilitates the communication using a handset of the first communication device.

15. The medium according to claim 14, wherein the step of confirming a peripheral status and a placement status of the first communication device, and selecting a communication mode according to the peripheral status, the placement status of the first communication device, and the division standards comprises:
determining if the first communication device is connected with a headset; and
selecting the headset mode if the first communication device is connected with the headset.

16. The medium according to claim 14, wherein the step of confirming a peripheral status and a placement status of the first communication device, and selecting a communication mode according to the peripheral status, the placement status of the first communication device, and the division standards further comprises:
detecting a gradient value of the first communication device if the first communication device is not connected with any headset; and
determining that the first communication device is placed horizontally if the gradient value is equal to about zero, and selecting the hands-free mode; or
determining that the first communication device is not placed horizontally if the gradient value is not equal to about zero, and selecting the hand-held mode.
